(19) United States
(12) Patent Application Publication
(10) Pub. No.: US 2025/0177854 A1
(43) Pub. Date: Jun. 5, 2025

(54) ELECTRONIC DEVICE USING CARRIER NETWORK AND METHOD FOR OPERATING THE SAME

(71) Applicant: Samsung Electronics Co., Ltd., Suwon-si (KR)

(72) Inventors: Jihyoung SON, Suwon-si (KR); Ankur SAHUWALA, Uttar Pradesh (IN)

(21) Appl. No.: 19/053,066

(22) Filed: Feb. 13, 2025

Related U.S. Application Data
(63) Continuation of application No. PCT/KR2023/009043, filed on Jun. 28, 2023.

(30) Foreign Application Priority Data
Aug. 18, 2022 (KR) 10-2022-0103646
Aug. 31, 2022 (KR) 10-2022-0110213

(51) Int. Cl. A63F 13/355; A63F 13/52; H04L 67/10

(52) U.S. Cl. CPC A63F 13/355; A63F 13/52; H04L 67/10; A63F 2300/535; A63F 2300/538

(57) ABSTRACT

An electronic device is disclosed. The electronic device comprises: a communication interface comprising circuitry; a memory storing background data corresponding to each of at least one game is stored; and at least one processor, comprising processing circuitry, individually and/or collectively, configured to: acquire first background data corresponding to first identification information and second identification information from among the stored background data based on a first device and a second device belonging to the same ground based on the first identification information received from the first device and the second identification information received from the second device, control the electronic device to transmit, to the first device, a first output frame corresponding to the first device, acquired from the first background data based on first location information in the background environment received from the first device and first viewpoint information about a user, and control the electronic device to transmit, to the second device, a second output frame corresponding to the second device, acquired from the first background data based on second location information in the background environment received from the second device and second viewpoint information about the user.

### CROSS-REFERENCE TO RELATED APPLICATIONS

This application is a continuation of International Application No. PCT/KR2023/009043 designating the United States, filed on Jun. 28, 2023, in the Korean Intellectual Property Receiving Office and claiming priority to Korean Patent Application Nos. 10-2022-0103646, filed on Aug. 18, 2022, and 10-2022-0110213, filed on Aug. 31, 2022, in the Korean Intellectual Property Office, the disclosures of each of which are incorporated by reference herein in their entireties.

### BACKGROUND

### Field

The disclosure relates to an electronic device that transmits frames to a plurality of devices and a control method thereof, and for example, to an electronic device that transmits frames generated based on data received from each of the plurality of devices and a control method thereof.

### Description of Related Art

With developments in electronic technology, electronic devices, in particular, server-based real-time rendering services are being supplied. Users may play games with other users in real-time through cloud games in which the real-time rendering services are mainly used. Most cloud games refer to games which have servers, that received user inputs, complete operation processing, and stream data, in real-time, for game screens corresponding to the user inputs to user devices. The cloud game may include on-line games in which multiple players participate in a 3-dimensional virtual space such as, for example, and without limitation, a multi-player first person shooting (FPS) game of a first person view-point.

Because a graphics processing unit (GPU) which performs rendering of a screen can perform rendering of only one frame in real-time, a rendering server corresponding to each user device is needed to stream a game screen in real-time to a plurality of users for cloud games.

Meanwhile, users belonging to a same playing group may typically play on a same map, and in this case, a problem of requiring an additional rendering process proportionate to a number of each user device may occur in order to provide a same background image.

### SUMMARY

According to an example embodiment, an electronic device includes: a communication interface comprising communication circuitry, a memory storing background data respectively corresponding to at least one game, and at least one processor, comprising processing circuitry, individually and/or collectively, configured to: obtain, based on a first device and a second device belonging to a same group based on first identification information received from the first device and second identification information received from the second device, first background data corresponding to the first identification information and the second identification information from among the stored background data; control the electronic device to transmit a first output frame corresponding to the first device, the first output frame being obtained from the first background data based on first position information in the background and first view-point point information received from the first device, to the first device; and control the electronic device to transmit a second output frame corresponding to the second device, the second output frame being obtained from the first background data based on second position information in the background and second view-point information received from the second device, to the second device.

At least one processor, individually and/or collectively, may be configured to: update the first output frame based on first input information received from the first device, and update the second output frame based on second input information received from the second device, and control the electronic device to transmit the updated first output frame to the first device and transmit the updated second output frame to the second device through the communication interface.

At least one processor, individually and/or collectively, may be configured to: perform rendering of each of a first primary frame including pixels with a same pixel value and a first secondary frame including pixels with different pixel values by comparing updated pixel data for each pixel based on pixel data corresponding to the first output frame and the first input information, and perform rendering of each of a second primary frame including pixels with a same pixel value and a second secondary frame including pixels with different pixel values by comparing updated pixel data for each pixel based on pixel data corresponding to the second output frame and the second input information.

The first primary frame and the second primary frame may be rendered based on the first background data, and the first secondary frame and the second secondary frame may be rendered based on the first input information and the second input information.

At least one processor, individually and/or collectively, may be configured to control the electronic device to: transmit each of the first primary frame and the first secondary frame to the first device, and transmit each of the second primary frame and the second secondary frame to the second device.

At least one processor, individually and/or collectively, may be configured to control the electronic device to: transmit the updated first output frame obtained based on the first primary frame and the first secondary frame to the first device, and transmit the updated second output frame obtained based on the second primary frame and the second secondary frame to the second device.

At least one processor may include a main processor, comprising processing circuitry, configured to: identify, with respect to a first group and a second group identified according to whether a game of a plurality of devices belong to a same group, background data corresponding to each of the first ground and the second group from among the stored background data, a first sub processor, comprising processing circuitry, configured to perform rendering of an output frame corresponding to a plurality of devices belonging to the first group based on background data corresponding to the first group, and a second sub processor, comprising processing circuitry, configured to perform rendering of an output frame corresponding to a plurality of devices belonging to the second group based on background data corresponding to the second group.

At least one processor, individually and/or collectively, may be configured to identify, based on connection with a same server of the first device and the second device being identified based on the first identification information and the second identification information, the first device and the second device as belonging to the same group.

The at least one game may be a multi-player cloud game that shares a same game environment.

According to an example embodiment, a method comprises: receiving identification information of a game being executed, position information in a background provided from the game, and view-point information from a first device and a second device, respectively; obtaining, based on the first device and the second device belonging to a same group based on first identification information of the game received from the first device and second identification information of the game received from the second device, first background data corresponding to the first identification information and the second identification information from among background data respectively corresponding to at least one game stored in a memory; and transmitting a first output frame corresponding to the first device, the first output frame being obtained from the first background data based on first position information in the background and first view-point information received from the first device, to the first device. The control method includes transmitting a second output frame corresponding to the second device, the second output frame being obtained from the first background data based on second position information in the background and second view-point information received from the second device, to the second device.

The method may further include: updating the first output frame based on first input information received from the first device, and updating the second output frame based on second input information received from the second device, and the transmitting may include transmitting the updated first output frame to the first device and transmitting the updated second output frame to the second device.

The method may include: performing rendering of each of a first primary frame which includes pixels with a same pixel value and a first secondary frame which includes pixels with different pixel values by comparing updated pixel data for each pixel based on pixel data corresponding to the first output frame and the first input information, and performing rendering of each of a second primary frame which includes pixels with a same pixel value and a second secondary frame which includes pixels with different pixel values by comparing updated pixel data for each pixel based on pixel data corresponding to the second output frame and the second input information.

The first primary frame and the second primary frame may be rendered based on the first background data, and the first secondary frame and the second secondary frame may be rendered based on the first input information and the second input information.

The transmitting may include transmitting each of the first primary frame and the first secondary frame to the first device, and transmitting each of the second primary frame and the second secondary frame to the second device.

The transmitting may include transmitting the updated first output frame obtained based on the first primary frame and the first secondary frame to the first device, and transmitting the updated second output frame obtained based on the second primary frame and the second secondary frame to the second device.

The method may include: identifying, with respect to a first group and a second group identified based on whether a game being executed in a plurality of devices belong to a same group, background data corresponding to each of the first ground and the second group from among the background data stored in the memory, performing rendering of an output frame corresponding to a plurality of devices belonging to the first group based on background data corresponding to the first group, and performing rendering of an output frame corresponding to a plurality of devices belonging to the second group based on background data corresponding to the second group.

The identifying whether a plurality of devices belong to a same group may include identifying, based on connection with a same server of the first device and the second device being identified based on the first identification information and the second identification information, the first device and the second device as belonging to the same group.

The at least one game may be a multi-player cloud game that shares a same game environment.

According to an example embodiment, a non-transitory computer-readable recording medium storing computer instructions which, when executed by at least one processor, comprising processing circuitry, of the electronic device, individually and/or collectively, causes the electronic device to perform at least one operation, the operation including: receiving identification information of a game being executed, position information in a background environment provided from the game, and view-point information from a first device and a second device, respectively; obtaining, based on the first device and the second device belonging to a same group based on first identification information of the game received from the first device and second identification information of the game received from the second device, first background data corresponding to the first identification information and the second identification information from among background data respectively corresponding to at least one game stored in a memory; transmitting a first output frame corresponding to the first device, the first output frame being obtained from the first background data based on first position information in the background and first view-point information received from the first device, to the first device; and transmitting a second output frame corresponding to the second device, the second output frame being obtained from the first background data based on second position information in the background and second view-point information received from the second device, to the second device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example control method of an electronic device according to various embodiments;

FIG. 2 is a block diagram illustrating an example configuration of an example electronic device according to various embodiments;

FIG. 3 is a flowchart illustrating an example method of controlling an electronic device according to various embodiments;

FIG. 4 is a diagram illustrating an example method of identifying a plurality of user devices into a same playing group according to various embodiments;

FIG. 5A and FIG. 5B are diagrams illustrating an example method of rendering an output frame based on background environment data according to various embodiments;

FIG. 6 is a diagram illustrating an example method of updating an output frame according to various embodiments;

FIG. 7 is a diagram illustrating an example method of rendering an output frame according to various embodiments;

FIG. 8A and FIG. 8B are flowcharts illustrating an example method of transmitting a frame to a user device according to various embodiments; and

FIG. 9 is a block diagram illustrating an example configuration of an electronic device according to various embodiments.

### DETAILED DESCRIPTION

The disclosure will be described in greater detail below with reference to the accompanying drawings.

Terms used in the disclosure will be briefly described, and the disclosure will be described in detail.

The terms used in the various embodiments of the disclosure are general terms selected that are currently widely used considering their function herein. However, the terms may change depending on intention, legal or technical interpretation, emergence of new technologies, and the like of those skilled in the related art. Further, in certain cases, there may be terms that are arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have,” “may have,” “include,” and “may include” are used to designate a presence of a corresponding characteristic (e.g., elements such as numerical value, function, operation, or component), and not to preclude a presence or a possibility of additional characteristics.

The expression at least one of A and/or B is to be understood as indicating any one of “A” or “B” or “A and B.”

Expressions such as “1st”, “2nd”, “first” or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used herein perform at least one function or operation, and may be implemented with a hardware or software, or implemented with a combination of hardware and software. In addition, a plurality of “modules” or a plurality of “parts,” except for a “module” or a “part” which needs to be implemented to a specific hardware, may be integrated in at least one module and implemented as at least one processor (not shown).

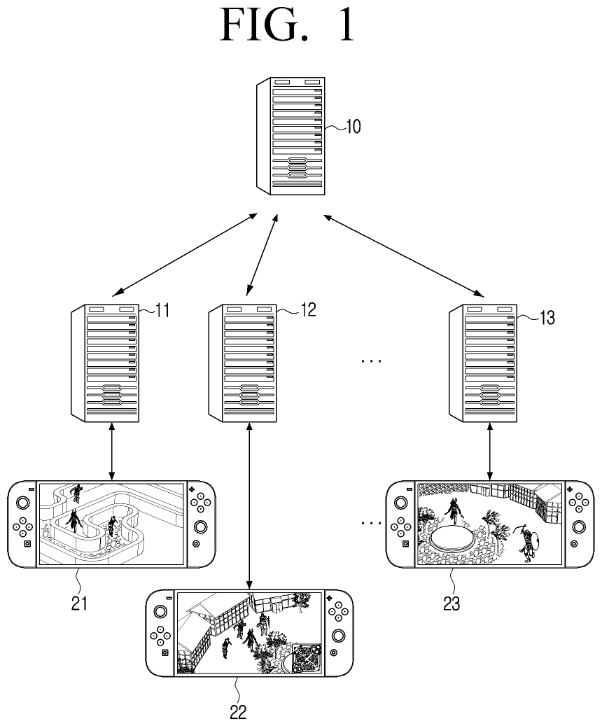

FIG. 1 is a diagram illustrating an example method of controlling an electronic device according to various embodiments.

Referring to FIG. 1, according to an embodiment, an electronic device 10 which received a plurality of users input information (e.g., view-point information of a player and user command information) received from a plurality of user devices 21, 22, . . . , 23 belonging to a same playing group (or, same group) may perform rendering of a game screen based on a game space (e.g., a virtual space in a game performing the game) in which the above-described playing group is playing and user input information received from a user device, and provide a rendered game screen to the user device. According to an example, the user device may be implemented as electronic devices of various types which can input a signal for a user to play a game, and display a game screen corresponding to the input signal such as, for example, and without limitation, a smartphone, a tablet personal computer (PC), a wearable device, a game console, and the like.

If the electronic device 10 is implemented as a server, because a graphics processing unit (GPU) included in the electronic device 10 can perform rendering of only one game screen at a time, rendering has to be performed in servers 11, 12, . . . , and 13 corresponding to each of the plurality of users, respectively, in order to perform rendering of the game screen to the plurality of users simultaneously.

Users belonging to the same playing group may typically play on a same map, and the plurality of users may play within a same background image (or, a virtual background space). If rendering is performed through servers corresponding to each of the user devices in order to provide a game screen simultaneously to the plurality of users, each of the servers 11, 12, . . . , and 13 corresponding to the user devices may respectively perform rendering of the background image. That is, a problem of requiring additional rendering processes proportionate to a number of respective user devices may be generated in order to provide the same background image.

Accordingly, various embodiments in which rendering is prevented/inhibited from being repeatedly performed for screens that overlap by performing rendering of the background image using data on the background environment and user attribute information received from the user device will be described below.

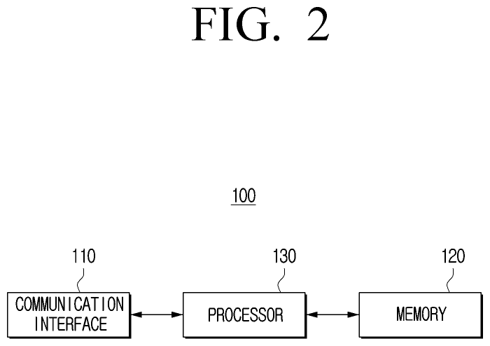

FIG. 2 is a block diagram illustrating an example configuration of an electronic device according to various embodiments.

Referring to FIG. 2, an electronic device 100 may include a communication interface (e.g., including communication circuitry) 110, a memory 120, and a processor (e.g., including processing circuitry) 130.

The electronic device 100 may be implemented with a server or devices of various types which can provide content such as, for example, and without limitation, a content providing server, personal computer (PC), or the like. The electronic device 100 may be a system itself in which a cloud computing environment is built. According to an embodiment, the electronic device 100 may be implemented with various forms of servers, such as, for example, and without limitation, a cloud server, an embedded server, and the like. According to an embodiment, the electronic device 100 may be implemented with a plurality of servers.

However, the above is not limited thereto, and the electronic device 100 according to an embodiment may be implemented with a user device. Accordingly, data may be transmitted and received by performing communication between user devices without having to perform communication through a separate server. However, for convenience of description, an embodiment of the electronic device 100 being implemented with a server will be described below.

The communication interface 110 may include various communication circuitry and receive input of content of various types. For example, the communication interface 110 may receive input of signals in a streaming or download method from an external device (e.g., a source device), an external storage medium (e.g., a USB memory), an external server (e.g., WEBHARD), and the like through communication methods such as, for example, and without limitation, an AP based Wi-Fi (wireless LAN network), Bluetooth, ZigBee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like.

According to an example, the communication interface 110 may use the same communication module (e.g., Wi-Fi) to communicate with an external device and an external server such as a remote control device.

According to an example, the communication interface 110 may use a different communication module to communicate with the external device and external server such as the remote control device. For example, the communication interface 110 may use at least one from among an Ethernet module or Wi-Fi to communicate with the external server, and use a Bluetooth module to communicate with the external device such as the remote control device. However, the above is merely an example embodiment, and the communication interface 110 may use at least one communication module from among various communication modules when communicating with a plurality of external devices or the external server.

The memory 120 may store data necessary for various embodiments. The memory 120 may be implemented in a form of a memory embedded in the electronic device 100 according to a data storage use, or in a form of a memory attachable to or detachable from the electronic device 100. For example, data for driving the electronic device 100 may be stored in the memory embedded in the electronic device 100, and data for an expansion function of the electronic device 100 may be stored in the memory attachable to or detachable from the electronic device 100. Meanwhile, the memory embedded in the electronic device 100 may be implemented as at least one from among a volatile memory (e.g., a dynamic RAM (DRAM), a static RAM (SRAM), or a synchronous dynamic RAM (SDRAM)), or a non-volatile memory (e.g., one time programmable ROM (OTPROM), programmable ROM (PROM), erasable and programmable ROM (EPROM), electrically erasable and programmable ROM (EEPROM), mask ROM, flash ROM, a flash memory (e.g., NAND flash or NOR flash), a hard disk drive (HDD) or a solid state drive (SSD)). In addition, the memory attachable to or detachable from the electronic a device 100 may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., USB memory) connectable to a USB port, or the like.

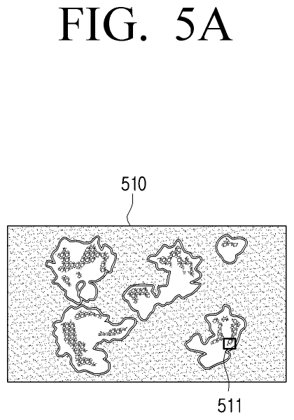

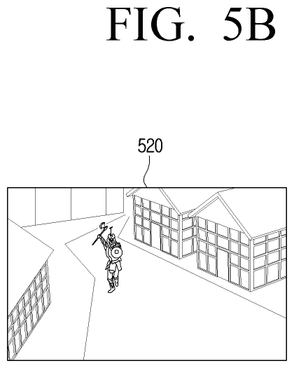

According to an embodiment, the memory 120 may store background environment data (or background data) respectively corresponding to at least one game. According to an embodiment, the memory 120 may store background environment data corresponding respectively to at least one map within at least one game. The background environment data may be a background image of a game that a user is playing or image data for a virtual space that the user is playing, and the background environment data according to an example may be a 3-dimensional (3D) image data. According to an example, the background environment data may include image data for a whole map in a game played by the user. The background environment data will be described in greater detail below with reference to FIG. 5A and FIG. 5B.

One or more processors 130 (hereinafter, referred to as a processor) may include various processing circuitry and control an overall operation of the electronic device 100 which is electrically connected with the communication interface 110. The processor 130 may be configured of one or a plurality of processors. For example, the processor 130 may perform, by executing at least one instruction stored in the memory 120, an operation of the electronic device 100 according to the various embodiments of the disclosure.

According to an embodiment, the processor 130 may be implemented as a digital signal processor (DSP) for processing a digital image signal, a microprocessor, a graphics processing unit (GPU), an artificial intelligence (AI) processor, a neural processing unit (NPU), or a time controller (TCON). However, the disclosure is not limited thereto, and may include one or more from among a central processing unit (CPU), a micro controller unit (MCU), a micro processing unit (MPU), a controller, an application processor (AP), a communication processor (CP), or an ARM processor, or may be defined by the corresponding term. In addition, the processor 130 may be implemented as a System on Chip (SoC) or a large scale integration (LSI) in which a processing algorithm is embedded, and may be implemented in a form of an application specific integrated circuit (ASIC) or a field programmable gate array (FPGA).

According to an embodiment, the processor 130 may be implemented as a digital signal processor (DSP), a microprocessor, or a time controller (TCON). However, the disclosure is not limited thereto, and may include one or more from among a central processing unit (CPU), a micro controller unit (MCU), a micro processing unit (MPU), a controller, an application processor (AP), a communication processor (CP), or an ARM processor, or may be defined by the corresponding term. In addition, the processor 130 may be implemented as a System on Chip (SoC) or a large scale integration (LSI) in which a processing algorithm is embedded, and may be implemented in a form of a field programmable gate array (FPGA).

The processor 130 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor 130 may receive user attribute information from a user device through the communication interface 110. Here, the user attribute information may be information on at least one from among a form, a position, a view-point, a state, or a movement of a character corresponding to the user (or, a player), and may include at least one from among, for example, identification information of a game being executed in a user device, information on a position of the user within a background environment provided in the game, or information on a view-point of the user. However, the above is not limited thereto, and command information of the user may also be included.

According to an example, the at least one game may be a multi-player cloud game that shares the same game environment. According to an example, the game may be a 3-dimensional (3D) game in which multiple players participate in a 3D virtual space such as, for example, and without limitation, a first person view-point multi-player first person shooting (FPS) game, a massive multiplayer online role-playing game (MMORPG) game, and the like.

According to an example, identification information may include at least one from among information on a type of game that is to be executed (or is being executed) in a user device and a type of map within a game that is to be executed, or an internet protocol (IP) address information of a server to which the user device is to be allocated. For example, if the IP address of the server to which the plurality of user devices executing the same game (or, a same map within the same game) is to be allocated is the same, the processor 130 may identify that the plurality of user devices is playing the same game according to each of the identification information of the game received from the plurality of user devices.

Information on a position of the user in the background environment provided in the game may be information on a relative position of a character corresponding to the user in the background environment, and information on a view-point of the user may be information on a viewing angle of the user in the background environment.

According to an example, the processor 130 may receive each of the identification information of the game being executed through a first user device from the first user device, the position information in the background environment of the user corresponding to the first user device (or a character in the game corresponding to the user), and a view-point information of a first user from among the plurality of user devices performing communication with the electronic device 100 such as the server. According to an example, the processor 130 may receive each of the identification information of the game being executed through a second user device from the second user device, the position information in the background environment of the user corresponding to the second user device, and view-point information of a second user.

According to an embodiment, the processor 130 may identify whether the first user device and the second user device belong in the same playing group. Here, the same playing group may be, for example, a group in which interaction between the plurality of users playing in the same game or the same map in the same game is present. The same playing group may be a group with the same IP address of the allocated server. According to an example, the processor 130 may identify, based on the IP address information of the server to which the first user device is to be allocated and the IP address information of the server to which the second user device is to be allocated being the same based on first identification information of the game received from the first user device and second identification information of the game received from the second user device, the first user device and the second user device as the same playing group.

According to an example, the processor 130 may identify, based on the IP address information of the server to which the first user device and the second user device are to be allocated being the same, and the type of map being executed by first user device and the second user device being identified as the same, the first user device and the second user device as the same playing group. However, the above is not limited thereto, and if the type of map being executed in the first user device and the second user device is the same, and the first user device and the second user device are identified as in communication, the first and second user devices may be identified as the same playing group.

According to an embodiment, the processor 130 may identify the background environment data corresponding to the plurality of user devices which belong in the same playing group. According to an example, the processor 130 may identify, based on the first user device and the second user device being identified as belonging to the same playing group, first background environment data corresponding to the first identification information and the second identification information from among the background environment data stored in the memory 120.

According to an example, the processor 130 may identify the first background environment data corresponding to the game that the first user device and the second user device are playing based on the first identification information and the second identification information. The processor 130 may identify the first background environment data corresponding to a specific map in the game that the first user device and the second user device are playing based on the first identification information and the second identification information.

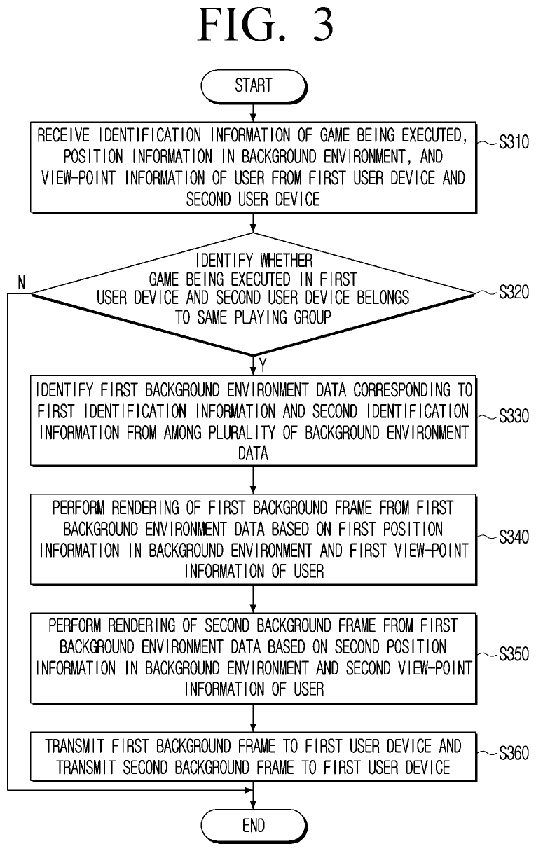

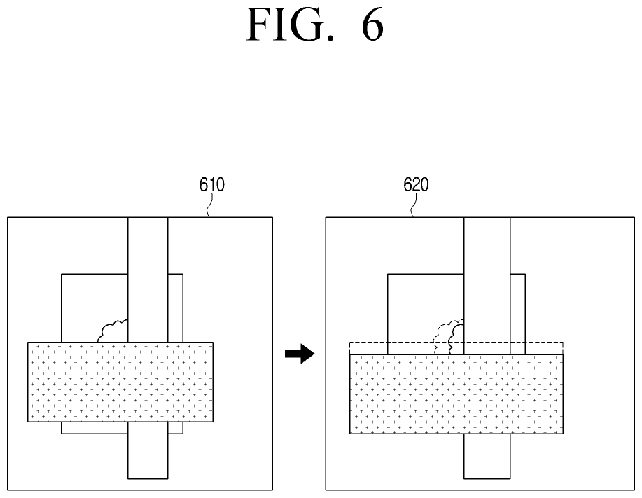

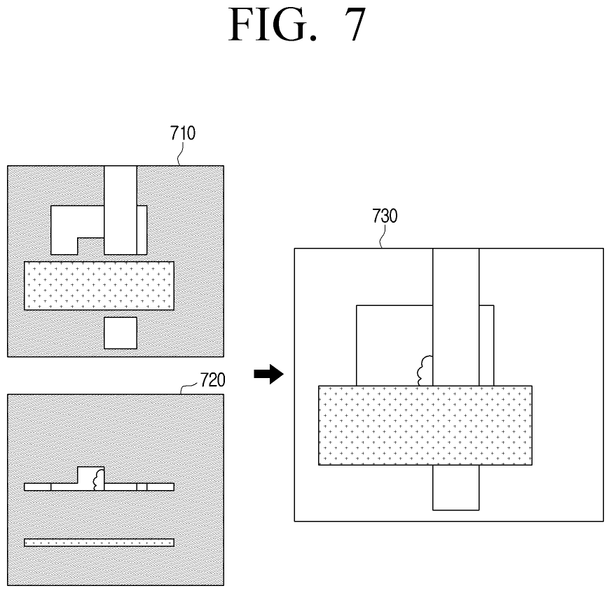

According to an embodiment, the processor 130 may perform rendering of an output frame based on user position information and view-point information received from the user device. According to an example, the processor 130 may perform rendering of a first output frame corresponding to the first user device from the first background environment data based on first position information in a background environment and first view-point information of the user received from the first user device through the communication interface 110, and perform rendering of a second output frame corresponding to the second user device from the first background environment data based on second position information in the background environment and second view-point information of the user received from the second user device. Here, the performing rendering of the output frame may refer, for example, to performing rendering of the output frame based on pixel data for the output frame obtained based on the background environment data. In this respect, the above will be described in greater detail below with reference to FIG. 3, and FIG. 5, FIG. 5B, FIG. 6 and FIG. 7.

According to an embodiment, the processor 130 may transmit the rendered output frame to the user device through the communication interface 110. According to an example, the processor 130 may transmit the first output frame to the first user device and transmit the second output frame to the second user device.

FIG. 3 is a flowchart illustrating an example method of controlling an electronic device according to various embodiments.

Referring to FIG. 3, a method according to an embodiment may include receiving identification information of a game being executed, position information in a background environment, and view-point information of a user from the first user device and the second user device (S310).

According to an example, the processor 130 may receive at least one from among type information of a game being executed in the first user device, map information in the game being executed, or IP address information for a server to which the first user device is to be allocated through the communication interface 110. The processor 130 may receive the position information in the background environment of the first user corresponding to the first user device and the view-point information of the user. According to an example, the processor 130 may receive at least one from among game type information of the second user device, the map information in the game being executed, or the IP address information for the server to which the first user device is to be allocated through the communication interface 110. Alternatively, the processor 130 may receive position information in a background environment of the second user and view-point information of the second user.

According to an embodiment, the method may include identifying whether the first user device and the second user device belong to a same playing group (S320). According to an example, the processor 130 may identify whether the game (or, map) being executed is the same based on the identification information (game type information and map information in the game) of the first user device and the second user device. According to an example, the processor 130 may identify, based on the received IP address information for the server to which each of the first user device and the second user device are to be allocated being the same, the first and second user devices as belonging to the same playing group.

According to an example, if the electronic device 10 is implemented with the plurality of servers, the processor 130 may allocate the plurality of user devices identified as belonging to the same playing group to one server included in the electronic device 100. For example, if a first server is allocated from among the plurality of servers included in the electronic device 100, the processor 130 included in the first server may transmit an output frame to the plurality of user devices identified as belonging to the same playing group through the communication interface 110.

According to an example, if the electronic device 100 is implemented with the plurality of servers, a first processor included in the first server from among the plurality of servers may identify whether the first user device and the second user device belong in the same playing group, and a second processor included in the second server from among the plurality of servers may perform rendering of an output frame to be transmitted to each of the user devices.

According to an embodiment, the control method may include identifying, based on the first user device and the second user device being identified as belonging to the same playing group (Y), the first background environment data corresponding to the first identification information and the second identification information from among a plurality of background environment data (S330). According to an example, if the first user device and the second user device are identified as belonging to the same playing group, the processor 130 may identify the type information of the game being played in the first and second user devices based on the identification information received from the first user device and the second user device through the communication interface 110, and identify the background environment data corresponding to the identified game type information based on the information stored in the memory 120.

According to an example, the processor 130 may identify type information of a map in the game being played by the first and second user devices based on identification information received from the first user device and the second user device through the communication interface 110, and identify the background environment data corresponding to the identified map type information based on the information stored in the memory 120.

According to an embodiment, the method may include performing rendering of the first output frame from the first background environment data based on the first position information in the background environment and the first view-point information of the user (S340).

According to an example, the processor 130 may obtain coordinate information corresponding to a first position in the background environment (the background environment corresponding to the first background environment data) of the first user (or, a character in a game environment corresponding to the first user).

According to an example, the processor 130 may identify background environment data for pixels corresponding to a position in a threshold range (or, a threshold pixel range) from the first position in the background environment from among the first background environment data based on the obtained coordinate information.

According to an example, the processor 130 may update the background environment data corresponding to the identified pixel range based on the view-point information of the first user, and identify the updated background environment data. However, the above is not limited thereto, and the processor 130 may identify the threshold pixel range taking into consideration the position information in the background environment and the view-point information of the first user, and identify the background environment data for the pixels corresponding to the position in the identified threshold pixel range.

According to an example, the processor 130 may identify the updated background environment data for the pixels corresponding to the position in the identified pixel range as pixel data corresponding to the first output frame, and perform rendering of the first output frame based therefrom.

According to an embodiment, the method may include performing rendering of the second output frame from the first background environment data based on the second position information in the background environment and the second view-point information of the user (S350).

According to an example, the processor 130 may obtain coordinate information corresponding to a second position in the background environment (the background environment corresponding to the first background environment data) of the second user (or, a character in a game environment corresponding to the second user).

According to an example, the processor 130 may identify the background environment data for pixels corresponding to the position in the threshold range (or, the threshold pixel range) from the second position in the background environment from among the first background environment data based on the obtained coordinate information. The processor 130 may update the background environment data corresponding to the identified pixel range based on the view-point information of the second user, and identify the updated background environment data. However, the above is not limited thereto, and the processor 130 may identify the threshold pixel range taking into consideration the position information in the background environment and the view-point information of the second user, and identify the background environment data for the pixels corresponding to the position in the identified pixel range.

According to an example, the processor 130 may identify the updated background environment data for the pixels corresponding to the position in the identified pixel range as pixel data corresponding to the second output frame, and perform rendering of the second output frame based therefrom.

According to an embodiment, the control method may include transmitting the first output frame to the first user device and transmitting the second output frame to the second user device (S360). According to an example, the processor 130 may transmit the rendered first output frame and second output frame to each of the first user device and the second user device through the communication interface 110.

Based on the above, the electronic device 100 may perform rendering based on background environment data of a game (or, a specific map in the game) and user attribute information. Accordingly, rendering cost may be reduced and GPU cost may also be reduced.

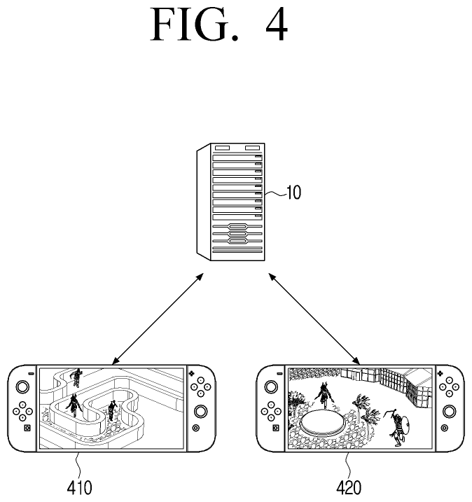

FIG. 4 is a diagram illustrating an example method of identifying a plurality of user devices into a same playing group according to various embodiments.

Referring to FIG. 4, according to an embodiment, the processor 130 may identify whether a first user device 410 and a second user device 420 belong in the same playing group based on first identification information of a game received from the first user device 410 and second identification information of a game received from the second user device 420.

According to an example, the processor 130 may identify whether IP address information for a server to which the first user device 410 is allocated received from the first user device 410 and IP address information for a server to which the second user device 420 is allocated received from the second user device 420 are the same.

According to an example, the processor 130 may identify, based on first user device 410 and the second user device 420 being identified as connected to a same server 400 based on the received first identification information and second identification information, the first user device 410 and the second user device 420 as belonging to the same playing group. Alternatively, according to an example, the processor 130 may identify, based on the IP address information for the server to which the first user device 410 is allocated received from the first user device 410 and the IP address information for the server to which the second user device 420 is allocated received from the second user device 420 being identified as the same, the first user device 410 and the second user device 420 as belonging to the same playing group.

FIG. 5A and FIG. 5B are diagrams illustrating an example method of rendering an output frame based on background environment data according to various embodiments.

Referring to FIG. 5A and FIG. 5B, according to an embodiment, the processor 130 may obtain background environment data respectively corresponding to at least one game based on information stored in the memory 120. The background environment data may be image data for a common background image of a game which the user is playing, and according to an example, the background environment data may be a 3-dimensional (3D) image data

According to an example, the background environment data may include image data for a whole map 510 in a game which the user is playing. For example, if the user is playing a specific map 510 of a specific game, the background environment data may be image data for the whole of the specific map 510 which the user is playing.

According to an embodiment, the processor 130 may identify, based on the game being executed (or, a specific map in the game being executed) by the user being identified based on the identification information received from the user device, background environment data corresponding to the identified game (or, map), and perform rendering of an output frame 520 corresponding to the user device from the background environment data based on the position information in the background environment and the view-point information of the user received from the user device.

According to an example, the processor 130 may obtain, based on the first user being identified as executing a game based on the first identification information received from the first user device, background environment data 510 for the game being executed by the first user based on information stored in the memory 120. According to an example, the processor 130 may perform rendering of a first output frame 520 based on the first position information and first view-point information of the first user received from the first user device through the communication interface 110.

For example, if the first user is position at a specific position in the game, the processor 130 may obtain relative coordinate information of the user in the game based on the first position information of the first user obtained from the first user device, and identify background environment data 511 corresponding to pixels corresponding to a position in the threshold range (or, the threshold pixel range) from the first position in the background environment from among the first background environment data based on the obtained coordinate information. The processor 130 may update a portion 511 from among the background environment data based on the obtained view-point information of the first user, and obtain the first output frame 520 by performing rendering of a portion from among the updated background environment data.

According to an example, the processor 130 may obtain, based on the second user being identified as executing the same game as the first user based on the second identification information received from the second user device, first background environment data 510 for the game being executed by the second user based on information stored in the memory 120. According to an example, the processor 130 may perform rendering of the second output frame based on the second position information and second view-point information of the second user received from the second user device through the communication interface 110. In this case, the processor 130 may obtain the second output frame in the same method as the method of obtaining the first output frame.

Based on the above, the processor 130 may perform rendering of a frame to be transmitted to the first and second user devices using data on the background environment of the game being played based on the first user and the second user belonging to the same playing group, and accordingly, the rendering cost may be reduced compared to when the frame is rendered by each of the plurality of processors.

FIG. 6 is a diagram illustrating an example method of updating an output frame according to various embodiments.

Referring to FIG. 6, according to an embodiment, the processor 130 may update an output frame based on user attribute information received from the user device. The output frame being updated may refer, for example, to pixel data corresponding to the obtained output frame being updated based on the user attribute information, and the output frame being updated based on the updated pixel data.

The user attribute information may be information on at least one from among a form, a position, a view-point, a state, or a movement of a character corresponding to the user (or, player), and may include at least one from among, for example, identification information of a game being executed in the user device, information on a position of the user in the background environment provided in the game, or information on the view-point of the user. However, the above is not limited thereto, and command information of the user may also be included.

According to an example, the processor 130 may update the first output frame 610 based on first user command information (or, first input information) received from the first user device, and update the second output frame based on second user command information (or, second input information) received from the second user device.

The user command information (or, input information) may be information on a user input for operating at least one from among a movement, a state, a position, or a form of a character corresponding to the user. However, the above is not limited thereto, and according to an example, user input information which is input while the user is playing the game may be included. For example, the processor 130 may update the first output frame based on the user input information received from the first device, for example, a character skill information corresponding to the first user.

For example, the processor 130 may update pixel data corresponding to the output frame based on the user input information or the user command information, and obtain the updated output frame by obtaining the output frame corresponding to the updated pixel data.

According to an embodiment, the processor 130 may transmit an updated output frame 620 to the user device through the communication interface 110. According to an example, the processor 130 may transmit the updated first output frame to the first user device and transmit the updated second output frame to the second user device, respectively.

According to an embodiment, the processor 130 may compare pixel data values of the output frame and the updated output frame, and perform rendering of a frame including pixels with the same pixel value and a frame including pixels of different pixel values, respectively. The above will be described in greater detail with reference to FIG. 7.

FIG. 7 is a diagram illustrating an example method of rendering an output frame according to various embodiments.

Referring to FIG. 7, according to an embodiment, the processor 130 may perform rendering of an output frame based on pixel data corresponding to the obtained output frame. According to an example, the processor 130 may perform rendering of a first primary frame 710 including pixels with the same pixel value and a first secondary frame 720 including pixels with different pixel values by comparing the updated pixel data for each pixel based on pixel data corresponding to the first output frame and the first user command information. According to an example, the processor 130 may write the first primary frame 710 and the first secondary frame 720 in the memory 120 in different frequencies, and perform rendering of the first primary frame 710 and the first secondary frame 720 by reading in a same frequency. Even if a low performance GPU is used, a high-resolution image frame may be output.

According to an example, the processor 130 may obtain a first output frame 730 by combining the rendered first primary frame 710 and first secondary frame 720, and transmit the above to the first user device through the communication interface 110. In an example, the processor 130 may combine the first primary frame 710 and the first secondary frame 720 using alpha blending. For example, the processor 130 may obtain the first output frame 730 based on an alpha blending image (or, an alpha map) corresponding to the first primary frame 710 and the first secondary frame 720. For example, an alpha value of a first pixel position of the first primary frame 710 may be set as 255, and an alpha value of a second pixel position of the first secondary frame 720 may be set as 0, and an image included in the first primary frame 710 and the first secondary frame 720 may be mixed. In another example, the processor 130 may mix the image included in the first primary frame 710 and the first secondary frame 720 based on pixel coordinate information corresponding to the first pixel position of the first primary frame 710 and pixel coordinate information corresponding to the first pixel position of the first secondary frame 720.

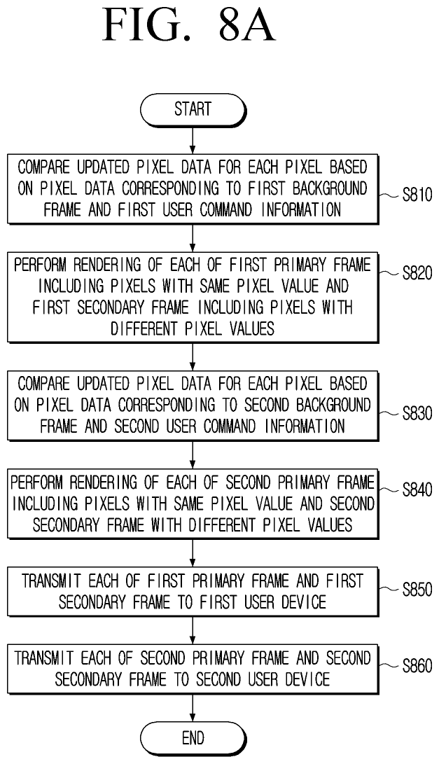

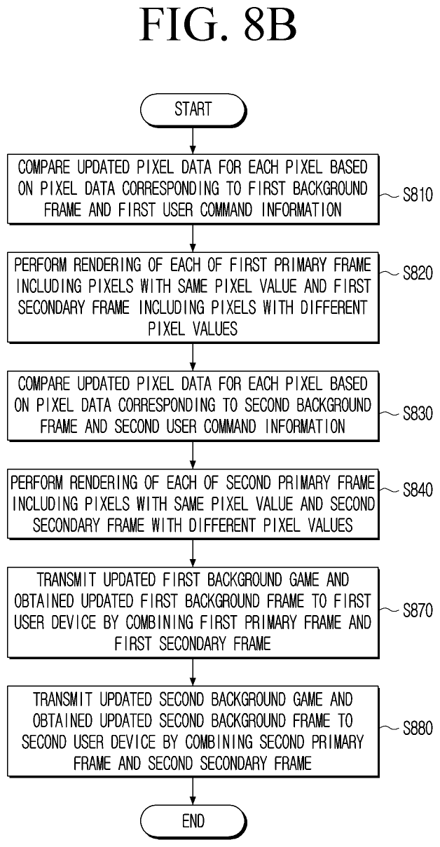

According to an example, the processor 130 may transmit each of the rendered first primary frame 710 and first secondary frame 720 t the first user device, and obtain the first output frame due to the first user device combining the above. The above will be described in detail through FIG. 8A and FIG. 8B.

According to an example, the processor 130 may perform rendering of each of a second primary frame including pixels with the same pixel value and a second secondary frame including pixels with different pixel values by comparing the updated pixel data for each pixel based on the pixel data corresponding to the second output frame and the second user command information.

According to an example, the processor 130 may obtain the second output frame by combining the rendered second primary frame and second secondary frame, and transmit the above to the second user device through the communication interface 110. According to an example, the processor 130 may transmit each of the rendered second primary frame and second secondary frame to the second user device, and obtain the second output frame due to the second user device combining the above. The above will be described in greater detail below with reference to FIG. 8A and FIG. 8B.

According to an embodiment, the first primary frame and the second primary frame may be respectively rendered based on the first background environment data. According to an embodiment, the first secondary frame and the second secondary frame may be respectively rendered based on the first user command information and the second user command information.

A primary frame corresponding to pixels with the same pixel value from among the output frame and the updated output frame may be pixels with no change in pixel value, and may be a portion that generally includes an image on the background environment. Accordingly, the processor 130 may obtain pixel values corresponding to the primary frame based on the obtained background environment data and thereby, efficient rendering may be possible therefrom.

A secondary frame may be a frame corresponding to pixels of which the frame is changed based on a user input or a user command, and because the processor merely has to perform rendering for pixels of a relatively small range compared to the primary frame, efficient rendering may be possible.

FIG. 8A and FIG. 8B are flowcharts illustrating an example method of transmitting a frame to a user device according to various embodiments.

Referring to FIG. 8A, the method according to an embodiment may include comparing the updated pixel data for each pixel based on the pixel data corresponding to the first output frame and the first user command information (S810). The control method according to an embodiment may include obtaining information on the first primary frame including pixels with the same pixel value and the first secondary frame including pixels with the different pixel values, respectively, and performing rendering of each of the first primary frame and the first secondary frame based on the obtained information (S820).

The method according to an embodiment may include comparing the updated pixel data for each pixel based on the pixel data corresponding to the second output frame and the second user command information (S830). The control method according to an embodiment may include obtaining information on the second primary frame including pixels with the same pixel value and the second secondary frame with different pixel values, respectively, and performing rendering of the second primary frame and the second secondary frame based on the obtained information (S840).

The method according to an embodiment may include transmitting each of the first primary frame and the first secondary frame to the first user device (S850). The method according to an embodiment may include transmitting each of the second primary frame and the second secondary frame to the second user device (S860).

Based on the above, the processor 130 may transmit each of the primary frame and the secondary frame corresponding to the obtained output frame to the user device, and the user device may obtain the output frame by combining the received primary frame and secondary frame. However, the above is not limited thereto, and the processor 130 may transmit the output frame obtained by combining the primary frame and the secondary frame to the user device as in FIG. 8B below.

Referring to FIG. 8B, according to an embodiment, the method in step S840 may include obtaining the first output frame by combining the first primary frame and the first secondary frame. According to an example, the processor 130 may obtain the combined first output frame by adding the first pixel of the obtained first primary frame and a pixel value of the first pixel of the first secondary frame corresponding to the position of the first pixel of the first primary frame. The method according to an embodiment may include transmitting the first output frame to the first user device (S870).

The method according to an embodiment may include obtaining the updated second output frame by combining the second primary frame and the second secondary frame. According to an example, the processor 130 may obtain the combined second output frame by adding the first pixel of the obtained second primary frame and a pixel value of the first pixel of the second secondary frame corresponding to the position of the above-described first pixel. The method according to an embodiment may include transmitting the obtained second output frame to the second user device (S880).

According to an embodiment, if the electronic device 100 is implemented with the user device, the electronic device 100 which is the user device may obtain information on an output frame corresponding to another user device through the above-described process, and transmit the above to the another user device through the communication interface 110.

According to an example, if the electronic device 100 is implemented with the first user device, the processor 130 may obtain each of the first primary frame and the first secondary frame for obtaining the first output frame, and obtain the first output frame by combining the above. The processor 130 may output the obtained first output frame through a display (not shown).

According to an example, if the electronic device 100 is implemented with the first user device, the processor 130 may obtain each of the second primary frame and the second secondary frame, and obtain the second output frame by combining the above. According to an example, the processor may transmit the obtained second output frame to the second user device through the communication interface 110.

According to an example, the electronic device 100 may transmit each of the second primary frame and the second secondary frame to the second user device through the communication interface 110. In this case, the processor 130 of the second user device may obtain the second output frame by combining the received second primary frame and second secondary frame.

Referring back to FIG. 2, according to an embodiment if the processor of the electronic device 100 is in plurality, the electronic device 100 may include each of a processor that identifies a plurality of playing groups and a processor that performs rendering of the output frame.

According to an embodiment, the one or more processors 130 may identify a first playing group and a second playing group based on whether the game being executed in the plurality of devices belong to the same playing group, and may include a main processor that identifies background environment data corresponding to each of the first playing group and the second playing group from among the background environment data stored in the memory, a first sub processor that renders an output frame corresponding to the plurality of user devices belonging to the first playing group based on the background environment data corresponding to the first playing group, and a second sub processor that renders the output frame corresponding to the plurality of user devices belonging to the second playing group based on the background environment data corresponding to the second playing group.

In this case, according to an example, the first playing group and the second playing group may be groups with different IP addresses of servers allocated to the users. Alternatively, according to an example, the first playing group and the second playing group may be groups playing games of different types or playing maps of different types.

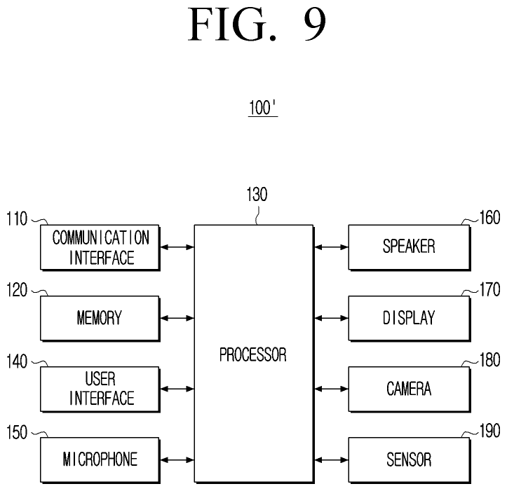

FIG. 9 is a block diagram illustrating an example configuration of an electronic device according to various embodiments.

Referring to FIG. 9, an electronic device 100′ may include the communication interface (e.g., including communication circuitry) 110, the memory 120, the processor (e.g., including processing circuitry) 130, a user interface (e.g., including interface circuitry) 140, a microphone 150, a speaker 160, a display 170, a camera 180, and a sensor 190. Detailed descriptions of configurations that overlap with the configurations shown in FIG. 2 from among the configurations shown in FIG. 9 may not be repeated here.

The user interface 140 may include various circuitry and be implemented with devices such as a button, a touch pad, a mouse, and a keyboard, or implemented as a touch screen, a remote control transmitting and receiving part, and the like capable of performing the above-described display function and an operation input function together therewith. The remote control transmitting and receiving part may receive a remote control signal from an external remote control device or transmit the remote control signal through at least one communication method from among an infrared communication, a Bluetooth communication, or a Wi-Fi.

The microphone 150 may refer to a module that obtains sound and converts to an electric signal, and may be a condenser microphone, a ribbon microphone, a moving-coil microphone, a piezoelectric device microphone, a carbon microphone, or a micro electro mechanical system (MEMS) microphone. In addition, the above may be implemented in an omnidirectional method, a bidirectional method, a unidirectional method, a sub cardioid method, a super cardioid method, or a hyper cardioid method.

There may be various embodiments of the electronic device 100 performing an operation corresponding to a user voice signal received through the microphone 150.

In an example, the electronic device 100 may control the display 170 based on the user voice signal received through the microphone 150. For example, if a user voice signal for displaying A content is received, the electronic device 100 may control the display 170 to display the A content.

In an example, the electronic device may control an external display device connected with the electronic device 100 based on the user voice signal received through the microphone 150. For example, the electronic device 100 may generate a control signal for controlling the external display device for an operation corresponding to the user voice signal to be performed in the external display device, and transmit the generated control signal to the external display device. Here, the electronic device 100 may store a remote control application for controlling the external display device. Further, the electronic device 100 may transmit the generated control signal to the external display device using the at least one communication method from among Bluetooth, Wi-Fi, or infrared rays. For example, if the user voice signal for displaying the A content is received, the electronic device 100 may transmit the control signal for controlling for the A content to be displayed in the external display device to the external display device. Here, the electronic device 100 may refer, for example, to various terminal devices in which the remote control application can be installed such as a smartphone and an AI speaker.

In an example, the electronic device 100′ may use the remote control device to control the external display device connected with the electronic device 100′ based on the user voice signal received through the microphone 150. For example, the electronic device 100′ may transmit a control signal for controlling the external display device for an operation corresponding to a user voice signal to be performed in the external display device to the remote control device. Then, the remote control device may transmit the control signal received from the electronic device 100′ to the external display device. For example, if the user voice signal for displaying the A content is received, the electronic device 100′ may transmit a control signal for controlling for the A content to be displayed in the external display apparatus to the remote control device, and the remote control device may transmit the received control signal to the external display device.

The speaker 160 may be formed of a tweeter for playing high-range sound, a midrange for playing mid-range sound, a woofer for playing low-range sound, a sub-woofer for playing ultra-low range sound, an enclosure for controlling resonance, a cross-over network dividing electric signal frequencies which are input to the speaker into bandwidths, and the like.

The speaker 160 may output sound signals to outside of the electronic device 100′. The speaker 160 may output playing of multi-media, playing of recordings, various notification sounds, voice messages, and the like. The electronic device 100′ may include audio output devices such as the speaker 160, but may include an output device such as an audio output terminal. Specifically, the speaker 160 may provide obtained information, information processed and manufactured based on the obtained information, a response result or operation result for a user voice, and the like in a voice form.

The display 170 may be implemented with a display including self-emissive devices or a display including non-emissive devices and a backlight. For example, the display 170 may be implemented with displays of various types such as, for example, and without limitation, a liquid crystal display (LCD), an organic light emitting diode (OLED) display, a light emitting diode (LED), a micro LED, a mini LED, a plasma display panel (PDP), a quantum dot (QD) display, a quantum dot light emitting diodes (QLED), or the like. In the display 170, a driving circuit, which may be implemented in a form of an a-si TFT, a low temperature poly silicon (LTPS) TFT, an organic TFT (OTFT), or the like, a backlight unit, and the like may be included. Meanwhile, the display 170 may be implemented as a touch screen coupled with a touch sensor, a flexible display, a rollable display, a 3D display, a display physically coupled with a plurality of display modules, or the like. The processor 130 may control the display 170 to output an output image obtained according to the various embodiments described above. Here, the output image may be a high-resolution image of 4K or greater than or equal to 8K.

According to an embodiment, the electronic device 100′ may include the display 170. Specifically, the electronic device 100′ may directly display the obtained image or content in the display 170.

According to an embodiment, the electronic device 100′ may not include the display 170. The electronic device 100′ may be connected with the external display device, and transmit the image or content stored in the electronic device 100′ to the external display device. For example, the electronic device 100′ may transmit the image or content together with a control signal controlling for the image or the content to be displayed in the external display device to the external display device.

The external display device may be connected with the electronic device 100′ through the communication interface 110 or an input and output interface (not shown). For example, the electronic device 100′ may not include a display such as a set top box (STB). In addition, the electronic device 100′ may include only a small-scale display which can display only simple information such as text information. Here, the electronic device 100′ may transmit the image or content to the external display device through the communication interface 110 via wired or wireless means or transmit the same to the external display device through the input and output interface (not shown).

The input and output interface (not shown) may be any one interface from among a high definition multimedia interface (HDMI), a mobile high-definition link (MHL), a universal serial bus (USB), a display port (DP), a Thunderbolt, a video graphics array (VGA) port, an RGB port, a D-subminiature (D-SUB), or a digital visual interface (DVI). The input and output interface (not shown) may input and output at least one from among an audio signal and video signal. According to an embodiment, the input and output interface (not shown) may include a port for inputting and outputting only the audio signal and a port for inputting and outputting only the video signal as separate ports, or may be implemented as one port for inputting and outputting both the audio signal and the video signal. Meanwhile, the electronic device 100′ may transmit at least one from among the audio signal and the video signal to the external device (e.g., the external display device or an external speaker) through the input and output interface (not shown). Specifically, an output port included in the input and output interface (not shown) may be connected with the external device, and the electronic device 100′ may transmit at least one from among the audio signal and the video signal to the external device through the output port.

The camera 180 may obtain an image by performing capturing of an area in a certain field of view (FoV). The camera 180 may include a lens which focuses visible rays reflected by objects and received and other optical signals to an image sensor and an image sensor which can detect the visible rays and other optical signals. Here, the image sensor may include a 2D pixel array which can be divided into a plurality of pixels.

The at least one sensor 190 (hereinafter, referred to as the ‘sensor’) may include a plurality of sensors of various types. The sensor 190 may measure a physical quantity or detect an operating state of the electronic device 100′, and convert the measured or detected information into an electric signal. The sensor 190 may include a camera, and the camera may include a lens which focuses visible rays reflected by objects and received and other optical signals to an image sensor and an image sensor which can detect the visible rays and other optical signals. Here, the image sensor may include a 2D pixel array which can be divided into a plurality of pixels, and the camera according to an example may be implemented with a depth camera. In addition, the sensor 190 may include a distance sensor such as a light detection and ranging (LIDAR) sensor and a time of flight (TOF) sensor.

In addition, the at least one sensor 190 may include at least one from among a gesture sensor, a gyro sensor, an atmospheric pressure sensor, a magnetic sensor, an acceleration sensor, a grip sensor, a proximity sensor, a color sensor (e.g., red, green, and blue (RGB) sensor), a biometric sensor, a temperature/humidity sensor, an illuminance sensor, or an ultra violet (UV) sensor.

The methods according to the various embodiments of the disclosure described above may be implemented in an application form installable in an electronic device of the related art. The methods according to the various embodiments of the disclosure described above may be performed using a deep learning-based trained neural network (or deep trained neural network), for example, a learning network model. In addition, the methods according to the various embodiments of the disclosure described above may be implemented with only a software upgrade, or a hardware upgrade for the electronic device of the related art. In addition, the various embodiments of the disclosure described above may be performed through an embedded server provided in the electronic device, or an external server of the electronic device.

According to an embodiment of the disclosure, the various embodiments described above may be implemented with software including instructions stored in a machine-readable storage media (e.g., computer). The machine may call a stored instruction from the storage medium, and as a device operable according to the called instruction, may include a display device (e.g., display device (A)) according to the above-mentioned embodiments. Based on a command being executed by the processor, the processor may directly or using other elements under the control of the processor perform a function corresponding to the command. The command may include a code generated by a compiler or executed by an interpreter. The machine-readable storage medium may be provided in a form of a non-transitory storage medium. Herein, the ‘non-transitory’ storage medium is tangible and may not include a signal, and the term does not differentiate data being semi-permanently stored or being temporarily stored in the storage medium.

In addition, according to an embodiment, a method according to the various embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

In addition, each of the elements (e.g., a module or a program) according to the various embodiments described above may be configured as a single entity or a plurality of entities, and a portion of sub-elements from among the above-mentioned sub-elements may be omitted, or other sub-elements may be further included in the various embodiments. Alternatively or additionally, a portion of the elements (e.g., modules or programs) may be integrated into one entity to perform the same or similar functions performed by the respective elements prior to integration. Operations performed by a module, a program, or another element, in accordance with the various embodiments, may be executed sequentially, in a parallel, repetitively, or in a heuristic manner, or at least a portion of the operations may be executed in a different order, omitted or a different operation may be added.

While the disclosure has been illustrated and described with reference to various example embodiments thereof, it will be understood that the various example embodiments are intended to be illustrative, not limiting. It will be understood by those skilled in the art that various changes in form and detail may be made therein without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a communication interface comprising circuitry;
a memory storing background data respectively corresponding to at least one game; and
at least one processor, comprising processing circuitry, individually and/or collectively, is configured to:
obtain, based on a first device and a second device belonging to a same group based on first identification information received from the first device and second identification information received from the second device, first background data corresponding to the first identification information and the second identification information from among the stored background data,
control the electronic device to transmit a first output frame corresponding to the first device, the first output frame being obtained from the first background data based on first position information in the background and first view-point information received from the first device, to the first device, and
control the electronic device to transmit a second output frame corresponding to the second device, the second output frame being obtained from the first background data based on second position information in the background and second view-point information from the second device, to the second device.

2. The electronic device of claim 1, wherein:
at least one processor, individually and/or collectively, is configured to:
update the first output frame based on first input information received from the first device, and update the second output frame based on second input information received from the second device, and
control the electronic device to transmit the updated first output frame to the first device and transmit the updated second output frame to the second device through the communication interface.

3. The electronic device of claim 2, wherein:
at least one processor, individually and/or collectively, is configured to:
perform rendering of each of a first primary frame comprising pixels with a same pixel value and a first secondary frame comprising pixels with different pixel values by comparing updated pixel data for each pixel based on pixel data corresponding to the first output frame and the first input information, and
perform rendering of each of a second primary frame comprising pixels with a same pixel value and a second secondary frame which comprises pixels with different pixel values by comparing updated pixel data for each pixel based on pixel data corresponding to the second output frame and the second input information.

4. The electronic device of claim 3, wherein:
the first primary frame and the second primary frame are rendered based on the first background data, and
the first secondary frame and the second secondary frame are rendered based on the first input information and the second input information.

5. The electronic device of claim 3, wherein:
at least one processor, individually and/or collectively, is configured to control the electronic device to:
transmit each of the first primary frame and the first secondary frame to the first device, and
transmit each of the second primary frame and the second secondary frame to the second device.

6. The electronic device of claim 3, wherein:
at least one processor, individually and/or collectively, is configured to control the electronic device to:
transmit the updated first output frame obtained based on the first primary frame and the first secondary frame to the first device, and
transmit the updated second output frame obtained based on the second primary frame and the second secondary frame to the second device.

7. The electronic device of claim 1, wherein:
at least one processor comprises:
a main processor configured to identify, with respect to a first group and a second group identified based on whether a game of a plurality of devices belong to a same group, background data corresponding to each of the first ground and the second group from among the stored background data;
a first sub processor configured to perform rendering of an output frame corresponding to a plurality of devices belonging to the first group based on background data corresponding to the first group; and
a second sub processor configured to perform rendering of an output frame corresponding to a plurality of devices belonging to the second group based on background data corresponding to the second group.

8. The electronic device of claim 1, wherein:
at least one processor, individually and/or collectively, is configured to:
identify, based on connection with a same server of the first device and the second device being identified based on the first identification information and the second identification information, the first device and the second device as belonging to the same group.

9. The electronic device of claim 1, wherein:
the at least one game is a multi-player cloud game that shares a same game environment.

10. A method of controlling an electronic device for transmitting frames to a plurality of devices, the method comprising:
receiving identification information of a game being executed, position information in a background provided from the game, and view-point information from a first device and a second device, respectively;
obtaining, based on the first device and the second device belonging to a same group based on first identification information of the game received from the first device and second identification information of the game received from the second device, first background data corresponding to the first identification information and the second identification information from among background data respectively corresponding to at least one game stored in a memory;
transmitting a first output frame corresponding to the first device, the first output frame being obtained from the first background data based on first position information in the background and first view-point information received from the first device, to the first device; and
transmitting a second output frame corresponding to the second device, the second output frame being obtained from the first background data based on second position information in the background and second view-point information received from the second device, to the second device.

11. The method of claim 10, further comprising:
updating the first output frame based on first input information received from the first device, and updating the second output frame based on second input information received from the second device,
wherein the transmitting comprises:
transmitting the updated first output frame to the first device and transmitting the updated second output frame to the second device.

12. The method of claim 11, comprising:
performing rendering of each of a first primary frame comprising pixels with a same pixel value and a first secondary frame comprising pixels with different pixel values by comparing updated pixel data for each pixel based on pixel data corresponding to the first output frame and the first input information, and
performing rendering of each of a second primary frame comprising pixels with a same pixel value and a second secondary frame comprising pixels with different pixel values by comparing updated pixel data for each pixel based on pixel data corresponding to the second output frame and the second input information.

13. The method of claim 12, wherein:
the first primary frame and the second primary frame are rendered based on the first background data, and
the first secondary frame and the second secondary frame are rendered based on the first input information and the second input information.

14. The method of claim 12, wherein:
the transmitting comprises:
transmitting each of the first primary frame and the first secondary frame to the first device, and transmitting each of the second primary frame and the second secondary frame to the second device.

15. A non-transitory computer-readable recording medium storing computer instructions that when executed by at least one processor, comprising processing circuitry, of an electronic device, individually and/or collectively, cause the electronic device to:
obtain, based on a first device and a second device belonging to a same group based on first identification information received from the first device and second identification information received from the second device, first background data corresponding to the first identification information and the second identification information from among background data respectively corresponding to at least one game stored in a memory,
control the electronic device to transmit a first output frame corresponding to the first device, the first output frame being obtained from the first background data based on first position information in the background and first view-point information received from the first device, to the first device, and
control the electronic device to transmit a second output frame corresponding to the second device, the second output frame being obtained from the first background data based on second position information in the background and second view-point information from the second device, to the second device.

16. The non-transitory computer-readable recording medium of claim 15, wherein the computer instructions further cause the electronic device to:
update the first output frame based on first input information received from the first device, and update the second output frame based on second input information received from the second device, and
control the electronic device to transmit the updated first output frame to the first device and transmit the updated second output frame to the second device through a communication interface.

17. The non-transitory computer-readable recording medium of claim 16, wherein the computer instructions further cause the electronic device to:
perform rendering of each of a first primary frame comprising pixels with a same pixel value and a first secondary frame comprising pixels with different pixel values by comparing updated pixel data for each pixel based on pixel data corresponding to the first output frame and the first input information, and
perform rendering of each of a second primary frame comprising pixels with a same pixel value and a second secondary frame which comprises pixels with different pixel values by comparing updated pixel data for each pixel based on pixel data corresponding to the second output frame and the second input information.

18. The non-transitory computer-readable recording medium of claim 17, wherein:
the first primary frame and the second primary frame are rendered based on the first background data, and
the first secondary frame and the second secondary frame are rendered based on the first input information and the second input information.

19. The non-transitory computer-readable recording medium of claim 17, wherein the computer instructions further cause the electronic device to:
transmit each of the first primary frame and the first secondary frame to the first device, and
transmit each of the second primary frame and the second secondary frame to the second device.

20. The non-transitory computer-readable recording medium of claim 17, wherein the computer instructions further cause the electronic device to:
transmit the updated first output frame obtained based on the first primary frame and the first secondary frame to the first device, and
transmit the updated second output frame obtained based on the second primary frame and the second secondary frame to the second device.
